(19) United States
(12) Patent Application Publication
(10) Pub. No.: US 2013/0191561 A1
(43) Pub. Date: Jul. 25, 2013

(54) DATA READING DEVICE, COMMUNICATION DEVICE, DATA READING METHOD AND PROGRAM

(71) Applicant: Yuuichi Aoki, Kawasaki-shi (JP)

(72) Inventor: Yuuichi Aoki, Kawasaki-shi (JP)

(73) Assignees: NTT DOCOMO, INC., Chiyoda-ku, Tokyo (JP); NEC CASIO MOBILE COMMUNICATIONS, LTD., Kawasaki-shi, Kanagawa (JP)

(21) Appl. No.: 13/877,703

(22) PCT Filed: Oct. 5, 2011
(86) PCT No.: PCT/JP2011/072963

§ 371 Date: Apr. 4, 2013

(30) Foreign Application Priority Data
Oct. 7, 2010 (JP) 2010-227281

(51) Int. Cl. G06F 5/14

(52) U.S. Cl. CPC G06F 5/14
USPC 710/57

(57) ABSTRACT

The wireless communication device of the present invention is provided with a received data FIFO for temporarily storing received data, and a data reading section for reading received data from the received data FIFO. The data reading section, when received data to be read is stored in the received data FIFO, reads and outputs the stored received data. Meanwhile, when the received data to be read is not stored in the received data FIFO and a predetermined condition is fulfilled, the data reading section outputs dummy received data. Furthermore, when the received data to be read is not stored in the received data FIFO and the predetermined condition is not fulfilled, the data reading section outputs an error.

### TECHNICAL FIELD

The present invention relates to a data reading device that, in a communication device that temporarily stores received data in first in, first out memory (hereinafter, referred to as FIFO), reads temporarily stored received data from the FIFO, and to a communication device that is equipped with this data reading device, and to a data reading method and program for this data reading device.

### BACKGROUND ART

In data communication that is performed using communication devices such as wireless communication devices, packet communication in which data is communicated in packet units is generally performed. A method of performing packet communication is known in which the communication device that receives the data in packet units stores the received data temporarily in a FIFO, and then performs data processing thereon. If this method is used, it is not necessary for the communication device to synchronize the timing when it receives data with the timing when it processes the data, and data processing can be performed with some degree of freedom as regards the timing thereof.

For example, in Patent document 1 a technology is disclosed in which a receiving device in the form of a television set is provided with a FIFO that temporarily stores a received data stream, and with a counter that shows the timings for extracting data from the FIFO, and in which the counting speed of the counter is changed in accordance with the volume of data that is stored in the FIFO. According to this technology, even if the clock speed on the transmitting side is different from the clock speed on the receiving side, it is possible to avoid the occurrence of overflow and underflow in the FIFO, and to process data without any of the data being deleted. Namely, video can be played back without any transmission gaps being generated.

In a communication system in which if a packet fails to arrive then that packet is retransmitted, it is necessary for the receiving-side communication device to firstly rearrange the received packets into the sequence in which they should have been transmitted originally before it performs data processing on them. Here, if a transmission is repeated because a packet has failed to arrive, the receiving-side communication device is not able to rearrange the packets until it receives the retransmitted packet, so that, in some cases, delays may occur in the data processing. Hereinafter, a delay in the data processing that occurs as a consequence of a packet being retransmitted will be described with reference made to FIG. 10 through FIG. 12.

FIG. 10 is a structural view showing an example of the schematic structure of a communication device provided with a FIFO for temporarily storing received data. In a wireless communication device 1001 shown in FIG. 10, when a wireless communication section 1100 receives a packet via a wireless signal, it demodulates the received wireless signal and outputs the demodulated packet to a reception/retransmission processing section 1210. The packet output from the wireless communication section 1100 may be a data packet in which data is stored, or a control packet in which commands (i.e., control information) relating to the wireless communication are stored.

When a packet is output from the wireless communication section 1100, then if the output packet is a data packet, the reception/retransmission processing section 1210 extracts the data from the payload area and outputs it to a received data FIFO 1220. On the other hand, when the packet output from the wireless communication section 1100 is a control packet, the reception/retransmission processing section 1210 extracts the command from the payload area and outputs it to a command processing section 1310.

Moreover, the reception/retransmission processing section 1210 also detects whether any packets have not arrived by referring to the sequence numbers contained in the packets. When the reception/retransmission processing section 1210 detects that a packet has not arrived, a transmission/retransmission processing section 1430 generates a retransmission request signal, and the wireless communication section 1100 modulates this retransmission request signal and transmits a wireless signal to the other communication device.

Furthermore, when the reception/retransmission processing section 1210 detects that a packet has not arrived, it temporarily stores the data or commands inside the reception/retransmission processing section 1210 instead of outputting them. The reception/retransmission processing section 1210 waits for the packet to be retransmitted, and then rearranges the temporarily stored data and commands in the sequence in which they were originally supposed to have been transmitted. In accordance with the rearranged sequence, the reception/retransmission processing section 1210 then outputs data to the received data FIFO 1220, and outputs commands to the command processing section 1310.

In contrast, a received data processing section 1250 reads and processes data from the received data FIFO 1220 at substantially regular intervals. At such times, if data that should be read is not present in the received data FIFO 1220 because a packet has failed to arrive or the like, ‘FIFO Empty Error’ is output.

FIG. 11 is a sequence diagram showing an operating example when ‘FIFO Empty Error’ is generated due to a packet failing to arrive.

In the example shown in FIG. 11, the wireless communication section 1100 outputs data packets or control packets to the reception/retransmission processing section 1210 at substantially regular intervals (i.e., at the sequences S1101, S1111, S1131, S1141, S1161, and S1171).

At the sequence S1121, the wireless communication section 1100 is not able to receive a communication signal, so that the wireless communication section 1100 does not output a data packet #2. Thereafter, at the point when the reception/retransmission processing section 1210 receives the output of a data packet #4 (i.e., at the sequence S1141), it temporarily stores the data #4 contained in the data packet #4 within the reception/retransmission processing section 1210 instead of storing it in the received data FIFO 1220. Next, after the reception/retransmission processing section 1210 has received the retransmission of the data packet #2 (i.e., at the sequence S1161), it rearranges the data in the sequence of: data #2, data #4, which is the sequence in which they were originally supposed to have been transmitted, and then stores them in the received data FIFO 1220 (i.e., at the sequences S1162, and S1164).

In contrast, the received data processing section 1250 reads data from the received FIFO 1220 data at substantially regular intervals (i.e., at the sequences S1201 and S1211).

At the point when the received data processing section 1250 reads the data at the sequence S1201, the data #0 has already been written in the received data FIFO 1220 (at the sequence S 1102), so that the received data processing section 1250 is able to acquire the data #0 (at the sequence S1202).

In contrast to this, at the point when the received data processing section 1250 reads the data at the sequence S1211, because the data packet #2 has not yet arrived (at the sequence S1121), there is no readable data stored in the received data FIFO 1220, and a FIFO Empty Error is generated (at the sequence S1212).

When a FIFO Empty Error is generated, the wireless communication device 1001, for example, firstly resets the communication, and then attempts to communicate once again. In this way, a FIFO Empty Error provides a useful opportunity for performing processing such as a reset when a temporary malfunction that blocks communication has occurred in the communication device, however, if FIFO Empty Errors occur too frequently, there is a possibility that the communication device will repeatedly reset and thereby generate a considerable delay in the communication.

For this reason, a method is known in which, in order to prevent FIFO Empty Errors from occurring too frequently, a wait time is provided in the timing when data is read from the FIFO.

FIG. 12 is a sequence diagram showing an operating example of a communication device in which a wait time is provided in the timing when data is read from the FIFO. In the example shown in FIG. 12, the received data processing section 1250 delays the timing at which it reads data from the received data FIFO 1220 by a predetermined wait time t1001. By doing this, at the point when the received data processing section 1250 reads the data at the sequence S1411, the data #2 is already stored in the received data FIFO 1220 so that the received data processing section 1250 is able to read this data #2. Accordingly, a FIFO Empty Error is not generated.

In this way, by providing a wait time in the timing when data is read from the received data FIFO 1220, the wireless communication device 1001 is able to prevent FIFO Empty Errors from occurring too frequently.

### DOCUMENTS OF THE PRIOR ART

### Patent Documents

[Patent document 1] Japanese Unexamined Patent Application, First Publication (JP-A) No. 2006-67158

### DISCLOSURE OF THE INVENTION

### Problems to be Solved by the Invention

As has been described above, by providing a wait time in the timing when data is read from the FIFO, it is possible to prevent FIFO Empty Errors from occurring too frequently. However, the timing when the received data processing section acquires data ends up being delayed.

The present invention was conceived in view of the above described circumstances and it is an object thereof to provide a communication device that prevents FIFO Empty Errors from occurring too frequently, and that enables a received data processing section to acquire data more rapidly.

### Means for Solving the Problem

This invention was conceived in order to solve the above described problems and a data reading device according to an aspect of the present invention is a data reading device that, in a communication device in which received data is temporarily stored in first in, first out memory (FIFO), reads the received data from the FIFO, is provided with: a read request receiving section that receives a read request for the received data; and a data output section that, when the read request receiving section receives the read request, then if the received data to be read is stored in the FIFO, reads and outputs the stored received data to be read, while if the received data to be read is not stored in the FIFO and predetermined conditions have been established, the data output section outputs dummy received data.

A communication device according to an aspect of the present invention is provided with: a receiving section that receives data; first in, first out memory (FIFO) that temporarily stores received data received by the receiving section; a data reading section that reads the received data from the FIFO; and a received data processing section that makes a request to the data reading section for received data, and processes received data output from the data reading section, wherein, when a request for received data is made from the data processing section, then if the received data to be read is stored in the FIFO, the data reading section reads and outputs the stored received data to be read, while if the received data to be read is not stored in the FIFO and predetermined conditions have been established, the data reading section outputs dummy received data.

A data reading method according to an aspect of the present invention is a data reading method for use in a communication device in which received data is temporarily stored in first in, first out memory (FIFO) and is provided with: a receiving step in which a receiving section receives data and stores it in the FIFO; a read request step in which the received data processing section requests the data reading section to read received data from the FIFO; and a data output step in which, when the data reading section receives the received data read request in the read request step, then if the received data to be read is stored in the FIFO, the data reading section reads and outputs the stored received data to be read, while if the received data to be read is not stored in the FIFO and predetermined conditions have been established, the data reading section outputs dummy received data.

A program according to an aspect of the present invention causes to be executed on a computer that is serving as a data reading device in a communication device in which received data is temporarily stored in first in, first out memory (FIFO) a data output step in which, when the data request is received, then if the received data to be read is stored in the FIFO, the stored received data to be read is read and output, while if the received data to be read is not stored in the FIFO and predetermined conditions have been established, dummy received data is output, while if received data to be read is not stored in the FIFO and the predetermined conditions have also not been established, an error is output.

### Effects of the Invention

According to the present invention, the effect is obtained that FIFO Empty Errors are prevented from occurring too frequently in a communication device, and a received data processing section of that communication device is able to acquire data more rapidly.

### BRIEF DESCRIPTION OF THE DRAWINGS

FIG. 1 is a block diagram showing a wireless communication device according to an embodiment of the present invention.

FIG. 2 is a data structure diagram showing the data in a packet received by a wireless communication section in the same embodiment.

FIG. 3 is a view showing saved data in first in, first out memory (FIFO) when received data is input in the same embodiment.

FIG. 4 is a view showing saved data in a FIFO when received data is input and a read request is received in the same embodiment.

FIG. 5 is a view showing saved data in a FIFO of the same embodiment when, from the state shown in FIG. 4, even more received data is input.

FIG. 6 is a sequence diagram showing an operation of the wireless communication device when a wireless signal is received in the same embodiment.

FIG. 7 is a flowchart showing an operation of a data reading section in the same embodiment.

FIG. 8 is a block diagram showing a wireless communication device in a variant example of the present invention.

FIG. 9 is a flowchart showing an operation of a data reading section in the same variant example.

FIG. 10 is a structural diagram showing a conventional communication device that is provided with a FIFO in which received data is temporarily stored.

FIG. 11 is a sequence diagram showing an operation when a ‘FIFO Empty Error’ is generated due to the non-arrival of a packet in the communication device shown in FIG. 10.

FIG. 12 is a sequence diagram showing an operation of a conventional communication device in which a wait time is provided in the timing when data is read from the FIFO.

### EMBODIMENTS FOR CARRYING OUT THE INVENTION

Hereinafter, embodiments of the present invention will be described with reference made to the drawings.

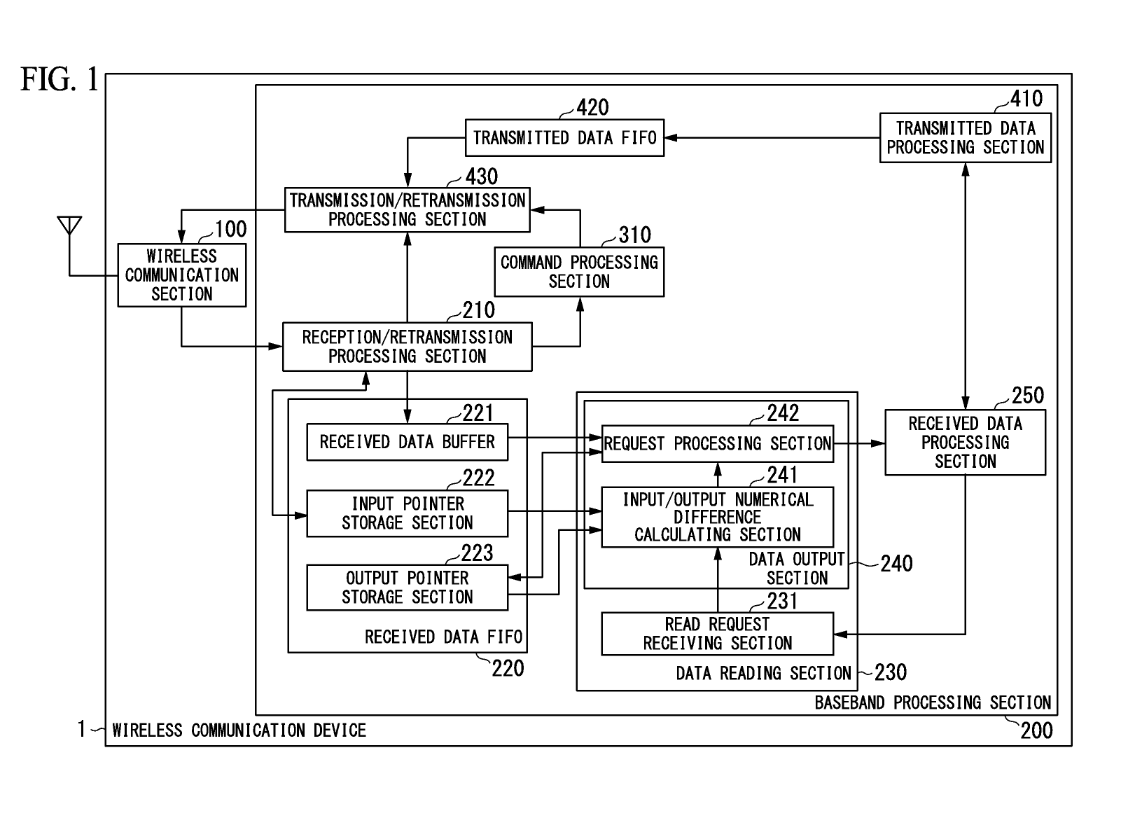

FIG. 1 is a structural view showing the schematic structure of a wireless communication device according to an embodiment of the present invention. In FIG. 1, a wireless communication device 1 is provided with a wireless communication section (i.e., receiving section) 100 and a baseband processing section 200. The baseband processing section 200 is provided with a reception/retransmission processing section 210, a received data FIFO (i.e., FIFO) 220, a data reading section 230, a received data processing section 250, a command processing section 310, a transmitted data processing section 410, a transmitted data FIFO 420, and a transmission/retransmission processing section 430. The received data FIFO 220 is provided with a received data buffer 221, an input pointer storage section 222, and an output pointer storage section 223. The data reading section 230 is provided with a read request receiving section 231, and a data output section 240. The data output section 240 is provided with an input/output numerical difference calculating section 241 and a request processing section 242.

The wireless communication section 100 is equipped with an antenna, and receives data packets and control packets via wireless signals. The wireless communication section 100 also performs demodulation processing on received wireless signals, and outputs the demodulated data packets and control packets to the baseband processing section 200.

The baseband processing section 200 extracts received data and commands (i.e., control information) in packet units from the data packets and control packets output from the wireless communication section 100, and restores the communication data based on the extracted commands.

The reception/retransmission processing section 210 extracts received data from the data packets output from the wireless communication section 100, and writes this received data in the received data FIFO 220. Moreover, the reception/retransmission processing section 210 extracts commands from the control packets output from the wireless communication section 100, and outputs these commands to the command processing section 310. In addition, when it detects that a packet has not arrived or that a packet contains errors, the reception/retransmission processing section 210 notifies this fact to the reception/retransmission processing section 210. Furthermore, when the reception/retransmission processing section 210 detects that a packet has not arrived or that a packet contains errors, it temporarily stores the received data and commands that it reads from the packets that are output from the wireless communication device 100 after this detection instead of outputting them. Then, after the reception/retransmission processing section 210 has received the retransmission of the undelivered packet or error packet, it rearranges the received data and commands into the sequence in which they were originally transmitted, and then writes received data in the received data FIFO, and outputs commands to the command processing section 310.

The received data FIFO 220 temporarily stores received data written in it by the reception/retransmission processing section 210.

The received data buffer 221 has a storage area that is divided into RAM blocks (Random Access Memory Blocks) that are used to temporarily store the received data written by the reception/retransmission processing section 210. The input pointer storage section 222 indicates which RAM block from among the RAM blocks in the received data buffer 221 is to be used by the reception/retransmission processing section 210 to write the received data in.

The output pointer storage section 223 indicates which RAM block from among the RAM blocks in the received data buffer 221 the received data that is to be read by the data reading section 230 is stored in.

The data reading section 230 reads received data from the received data FIFO 220 in accordance with the received data read request output from the received data processing section 250.

The read request receiving section 231 receives read requests for received data.

When the read request receiving section 231 receives a read request, then if the received data to be read is stored in the received data FIFO 220, the data output section 240 reads the stored received data that it needs to read, and then outputs this received data. If, on the other hand, the received data to be read is not stored in the received data FIFO 220, the data output section 240 outputs dummy received data. Note that the ‘received data to be read’ referred to here is received data from among the received data stored in the received data FIFO 220 that has not yet been read from the received data FIFO 220, and that has not had dummy received data output as a substitute for it.

The input/output numerical difference calculating section 241 determines an input/output numerical difference which is obtained by subtracting the number of received read requests from the number of received data inputs into the received data FIFO 220.

When the read request receiving section 231 receives a read request, then if the input/output numerical difference is a positive number (i.e., if the input/output numerical difference>0), the request processing section 242 reads received data from the received data FIFO 220 and outputs the received data. If, on the other hand the input/output numerical difference is 0 or is a value between 0 and a predetermined threshold value (i.e., if 0≧input/output numerical difference>threshold value), the request processing section 242 outputs dummy received data. Moreover, if the input/output numerical difference is equal to or less than the threshold value (i.e., input/output numerical difference≦threshold value), the request processing section 242 outputs an error.

The received data processing section 250 makes a request to read received data to the data reading section 230, and restores communication data from the received data in packet units output from the data reading section 230.

The command processing section 310 outputs control information to each of the sections of the wireless communication device 1 based on commands that are output from the reception/retransmission processing section 210. Note that the term ‘command’ here refers to control information prescribing the communication system to be used when the wireless communication device 1 is performing communication, and contains information such as the modulation system employed when the wireless communication section 100 modulates or demodulates wireless signals.

The transmitted data processing section 410 splits the data transmitted by the wireless communication device 1 into packet units and writes these in the transmitted data FIFO.

The transmitted data FIFO 420 temporarily stores the transmitted data in the packet units that were written in it by the transmitted data processing section 410.

The transmission/retransmission processing section 430 creates retransmission requests asking that a packet be retransmitted based on notifications of undelivered packets or packet errors output from the reception/retransmission processing section 210, and then outputs these retransmission requests to the wireless communication section 100.

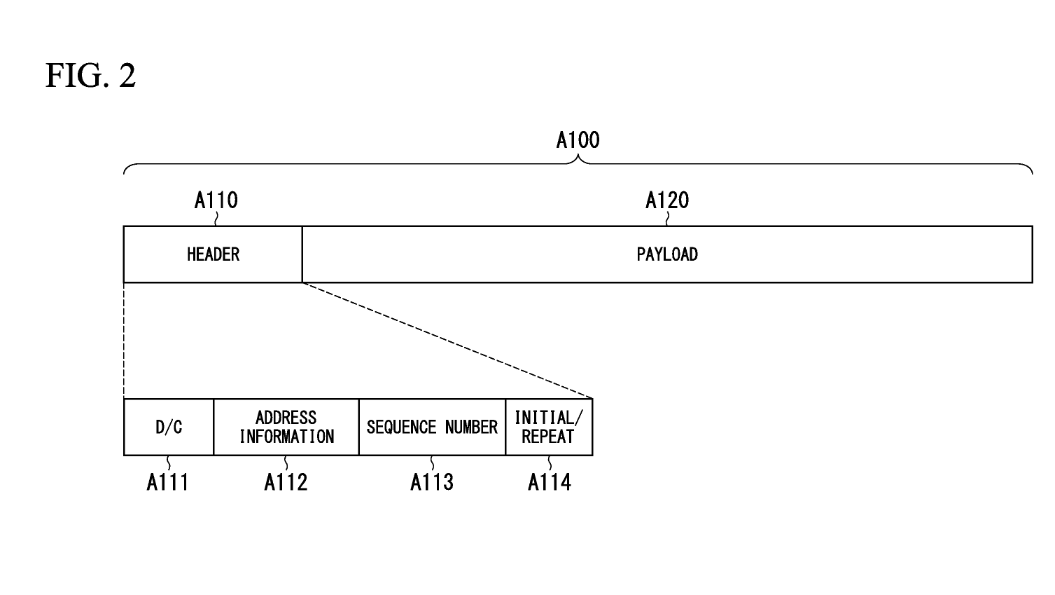

FIG. 2 is a data structure diagram showing an example of the data structure of a packet received by the wireless communication section.

In the present embodiment, communication data such as video and audio or wave data, and commands that are used to control the operations of each of each section of the wireless communication device 1 are all formed into packets prior to being communicated.

In FIG. 2, a packet A100 includes a header area A110 and a payload area A120.

The header area A110 includes a data/control flag area A111, an address information area A112, a sequence number area A113, and an initial transmission/retransmission flag area A114.

A data/control flag that show whether the contents of the payload are data or commands is stored in the data/control flag area A111.

Address information showing the destination address of the packet is stored in the address information area A112.

A sequence number that is used to identify the packet is stored in the sequence number area A113. The sequence number shows the packet transmission sequence, and is used for rearranging the packets into their transmitted sequence on the receiving side. Moreover, when a packet retransmission request is made, the sequence number is used to specify the packet that is to be retransmitted.

An initial transmission/retransmission flag that shows whether the packet is being transmitted for the first time or is being retransmitted is stored in the initial transmission/retransmission flag area A114.

Communication data or commands that have been split into packet units are stored in the payload area.

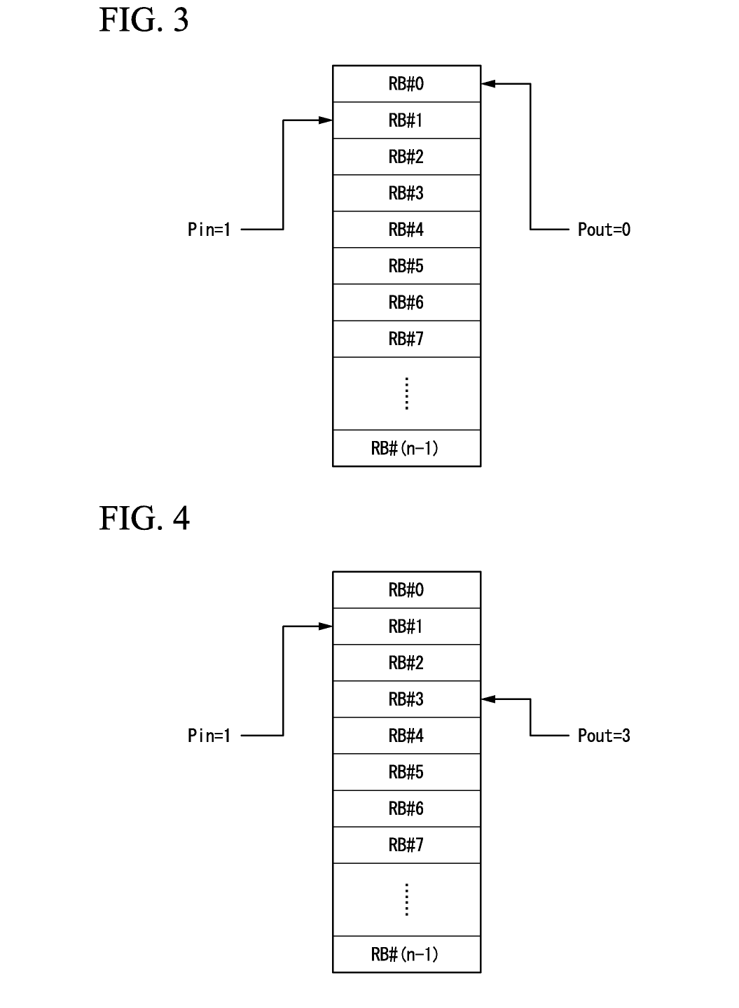

Next, the data structure of the FIFO formed by the received data FIFO 220 will be described with reference made to FIG. 3 through FIG. 5.

FIG. 3 is a view showing the state of the received data FIFO 220 when a single received data input is received. The received data buffer 221 of the received data FIFO 220 is provided with n (wherein n is a positive integer) number of RAM blocks RB #0˜RB #(n−1). Here, a RAM block is a storage area obtained by dividing the storage area provided in the received data buffer 221 into n number of areas, and each RAM block has sufficient volume to enable it to store all of the received data contained in one packet.

An input pointer Pin indicates the RAM block into which data is to be input, and shows the number of received data items that have been input into the received data FIFO 220 (including the number of received data items that have already been read). In the example shown in FIG. 3, one received data item has been input into the FIFO, and the value of the input pointer Pin is [1]. This [1] shows that the storage location for the received data that is to be input next into the received data FIFO 220 is the RAM block #1.

When received data is output from the reception/retransmission processing section 210, it is written into the RAM block indicated by the input pointer Pin, and 1 is added to the value of the input pointer Pin (i.e., the value thereof incremented by 1). Moreover, if the input pointer Pin is larger than n−1 which is the number of the last RAM block, the value of the input pointer Pin is returned to 0.

An output pointer Pout indicates the RAM block from which data is to be output, and shows the number of times that the data reading section 230 has received read requests from the received data processing section 250. In the example shown in FIG. 3, the data are reading section 230 has not yet received any read requests, so that the value of the output pointer Pout is [0]. This [0] shows that the storage location of the received data that is to be read when the received data FIFO 220 receives the next read request is the RAM block #0.

When the data reading section 230 receives a read request, the received data in the RAM block indicated by the output pointer Pout is read, and 1 is added to the value of the output pointer Pout. Moreover, if the output pointer Pout is larger than n−1, which is the number of the last RAM block, the value of the output pointer Pout is returned to 0.

FIG. 4 is a view showing the state of the received data FIFO 220 when a single received data input has been received, and three read requests have been received.

When the reception/retransmission processing section 210 receives a read request, then even if the received data to be read is not stored in the received data FIFO 220, 1 is added to the value of the output pointer Pout.

As a result of this, the value of the output pointer Pout becomes larger than the value of the input pointer Pin. In the example shown in FIG. 4, the value of the input pointer Pin is [1], while the value of the output pointer Pout is [3].

If there is no received data to be read in the received data FIFO 220, then as is described below, the data reading section 230 outputs dummy received data in response to the read request. In addition, if the value of the output pointer Pout is greater than the value of the input pointer Pin, then if received data has been input into the received data FIFO 220, then because dummy received data has already been output in place of this input received data, this input received data is treated as received data that has already been read. Namely, the data reading section 230 does not read or output this received data.

For example, if received data is input into the received data FIFO 220 from the state shown in FIG. 4, then although 1 is added to the value of the input pointer Pin so that this value becomes [2], this received data is not read by the data reading section 230.

Note that the received data FIFO 220 is provided with a cycle determination flag, and distinguishes between cases in which the value of the output pointer Pout is greater than the value of the input pointer Pin, and cases in which the input pointer Pin has completed one full cycle more than the output pointer Pout.

For example, if one data item is written in the received data processing section, then as is shown in FIG. 4, the value of pin becomes [1].

In contrast, the value of Pin also becomes [1] when n+1 data items are written in the received data processing section. Therefore, the received data FIFO 220 is provided with a cycle determination flag, and when the value of Pin is greater than the value of Pout, the value of the cycle determination flag is set to [1], while when the value of Pin is less than the value of Pout, the value of the cycle determination flag is set to [0].

Accordingly, when the value of the output pointer Pout is larger than the value of the input pointer Pin, the value of the cycle determination flag changes to [0], while when the input pointer Pin has completed one full cycle more than the output pointer Pout, the value of the cycle determination flag changes to [1], so that it is possible to discriminate between these two cases.

Note that if received data is input into the received data FIFO 220 while the value of the output pointer Pout is larger than the value of the input pointer Pin, then if the value of the input pointer Pin becomes larger than the value of the output pointer Pout, the data reading section 230 reads received data in accordance with the read request.

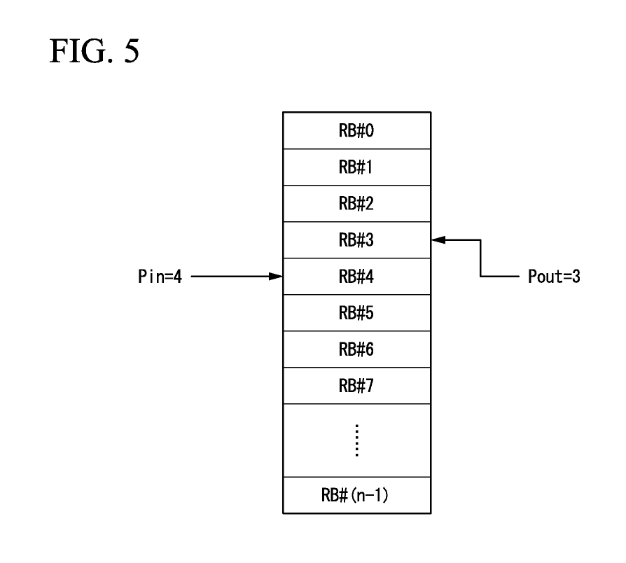

FIG. 5 shows the state of the received data FIFO 220 when the received data FIFO 220 receives three received data inputs from the state shown in FIG. 4. As a result of the received data FIFO 220 receiving three receives data inputs, the number of received data inputs, namely, [3] is added to the value [1] of the input pointer Pin in the state shown in FIG. 4, so that the value of the input pointer Pin changes to [4].

When the data reading section 230 receives a read request in the state shown in FIG. 5, the data reading section 230 reads the received data stored in the RAM block #4 and then outputs this received data.

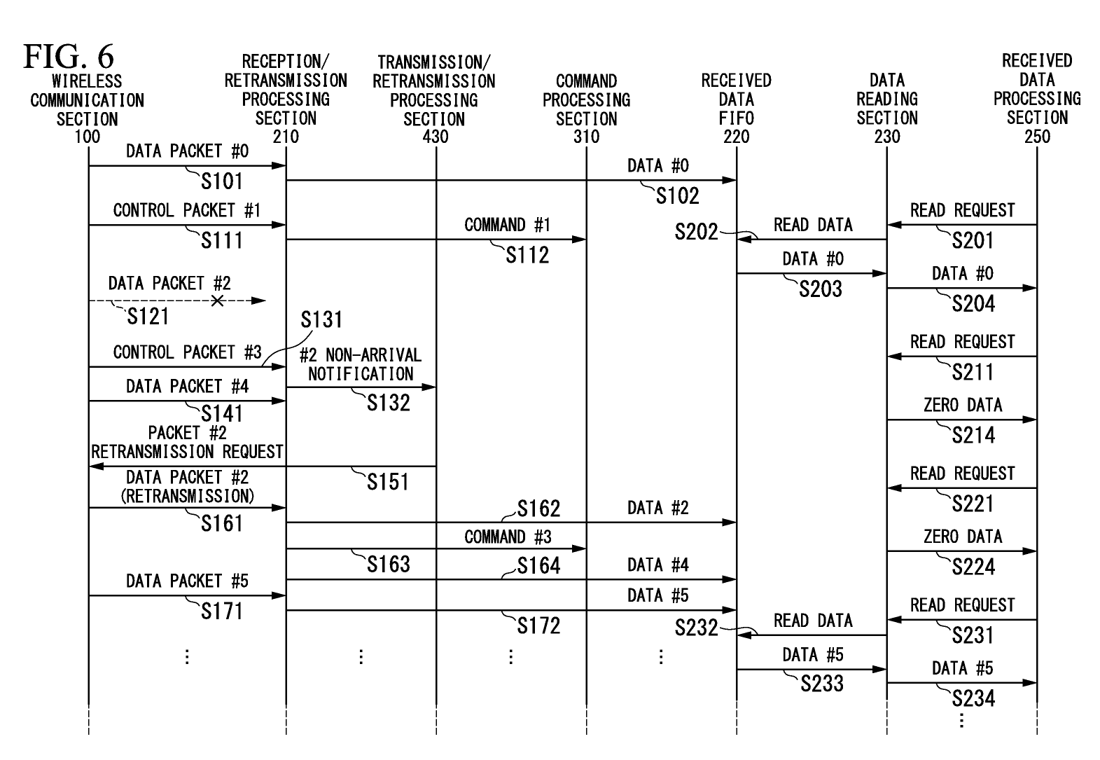

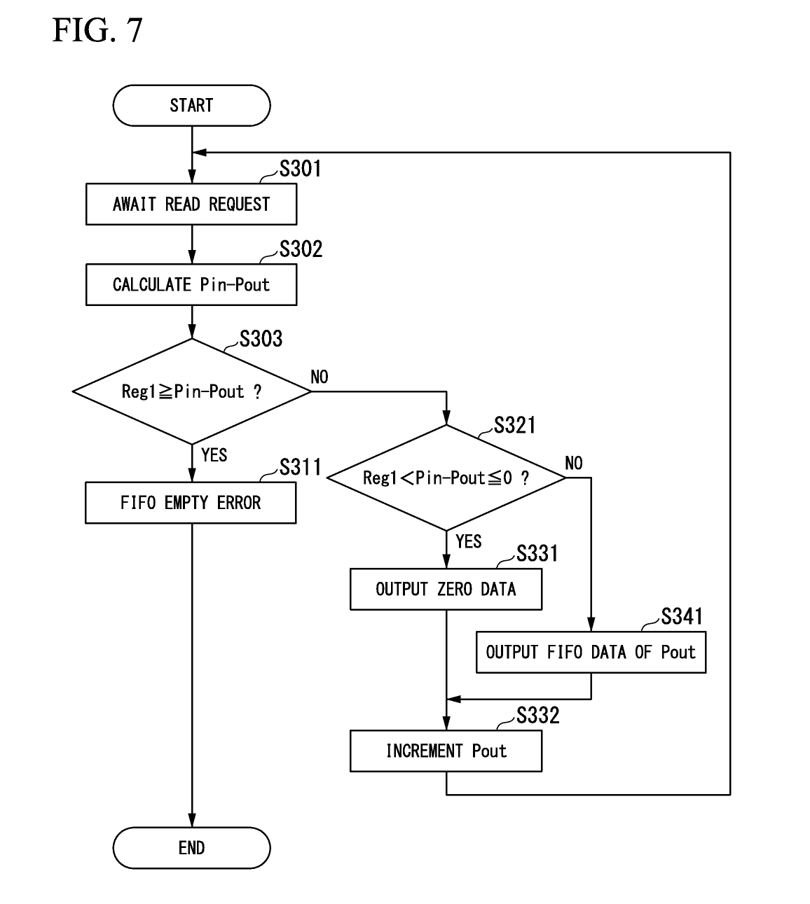

Next, an operation of the wireless communication device 1 when it receives a wireless signal will be described with reference made to FIG. 6 and FIG. 7. Firstly, an operation of the data reading section 230 will be described.

FIG. 6 is a sequence diagram showing an example of an operation of the wireless communication device 1 when it receives a wireless signal.

Firstly, when the wireless communication section 100 receives the data packet #0 via wireless signal, it demodulates this wireless signal and outputs the demodulated data packet #0 to the reception/retransmission processing section 210 (sequence S101).

The reception/retransmission processing section 210 then reads the received data #0 from the payload area for the data packet #0 that was output from the wireless communication section 100, and writes it in the received data FIFO 220 (sequence S102). Specifically, the reception/retransmission processing section 210 writes the received data in the RAM block #0 that is indicated by the value [0] of the input pointer Pin from among the RAM blocks in the received data buffer 221, and then adds 1 to the value of the input pointer Pin so that this value changes to [1]. As a result of this, the received data FIFO 220 changes to the state shown in FIG. 3.

Thereafter, when a read request is output from the received data processing section 250 to the read request receiving section 231 (sequence S201), the read request receiving section 231 outputs that read request to the input/output numerical difference calculating section 241. The input/output numerical difference calculating section 241 then calculates the input/output numerical difference, which is the difference obtained by subtracting the output pointer Pout from the input pointer Pin, and outputs the calculated input/output numerical difference to the request processing section 242. The request processing section 242 then determines whether or not this input/output numerical difference is equal to or less than a preset threshold value Reg1, and also determines whether or not this input/output numerical difference is equal to or less than 0.

Here, the input/output numerical difference is [1], which is greater than 0, and this shows that received data to be read is stored in the received data FIFO 220. Therefore, the request processing section 242 reads the received data #0 from the RAM block #0 from among the RAM blocks in the received data buffer 221 that is indicated by the value [0] of the output pointer Pout (sequences S202, S203), and outputs the read received data #0 to the received data processing section 250 (sequence S204).

On the other hand, when a control packet #1 is output from the wireless communication section 100 (sequence S111), the reception/retransmission processing section 210 reads the command from the payload area of the control packet #1, and writes it in the received data FIFO 220 (sequence S112).

Thereafter, the wireless communication section 100 is unable to receive the wireless signal containing the data packet #2, so that the data packet #2, which should have been the next packet to be output from the wireless communication section 100 after the control packet #1, is not output (sequence S121).

Next, when the control packet #3 is output from the wireless communication section 100 (sequence S131), the reception/retransmission processing section 210 refers to the sequence number of the control packet #3 and detects that the packet #2 has not yet arrived. It then outputs a non-arrival notification, which shows that the packet #2 has not yet arrived, to the reception/retransmission processing section 430 (sequence S132). Next, based on this non-arrival notification, the reception/retransmission processing section 430 creates a retransmission request that includes the sequence number of the packet #2, and outputs this to the wireless communication section 100 (sequence S151).

When the wireless communication section 100 receives the output of this retransmission request, it performs modulation processing on the output retransmission request so as to create a retransmission request signal, and then transmits this retransmission request signal to the partnering communication device (sequence S151).

The reception/retransmission processing section 210 reads the command #3 from the payload area of the control packet #3 that was output from the wireless communication section 100. However, at this point in time, because the packet #2 has not yet arrived, the reception/retransmission processing section 210 temporarily stores the command #3 in the reception/retransmission processing section 210 instead of outputting it to the command processing section 310.

Next, when the data packet #4 is output from the wireless communication section 100 (sequence S141), the reception/retransmission processing section 210 reads the data #4 from the payload area of the data packet #4. However, at this point in time, because the packet #2 has not yet arrived, the reception/retransmission processing section 210 temporarily stores the data #4 in the reception/retransmission processing section 210 instead of outputting it to the received data FIFO 220.

Moreover, when a wireless signal containing the data packet #2 is transmitted from the partnering communication device on the basis of the retransmission request signal that was transmitted at the sequence S151, the wireless communication section 100 receives the wireless signal of the data packet #2, and then demodulates this wireless signal so as to acquire the data packet #2. The wireless communication section 100 then outputs the acquired data packet #2 to the reception/retransmission processing section 210 (sequence S161).

Next, when the data packet #2 is output from the wireless communication section 100, the reception/retransmission processing section 210 detects from the sequence number of the data packet #2 that the undelivered data has been retransmitted.

The reception/retransmission processing section 210 then reads the received data #2 from the payload area of the data packet #2. The reception/retransmission processing section 210 then rearranges the data #2, and the temporarily stored command #3 and data #4 in their original transmission sequence, namely, in the sequence of the data #2, the command #3, and the data #4. The reception/retransmission processing section 210 then firstly outputs the data #2 to the received data FIFO 220 (sequence S162), and then outputs the command #3 to the command processing section 310 (sequence S163), and then finally outputs the data #4 to the received data FIFO 220 (sequence S164).

When the reception/retransmission processing section 210 receives from the wireless communication section 100 the output of the data packet #5 that was transmitted after the retransmission of the data packet #2 (sequence S171), it reads the data #5 from the data packet #5 and, after outputting the data #4 to the received data FIFO 220 at the sequence 5164, outputs the data #5 to the received data FIFO 220 (sequence S172).

In contrast, if a read request is output from the received data processing section 250 (sequence S211) prior to the data #2 being stored in the received data FIFO 220 at the sequence S162, the read request receiving section 231 outputs this output read request to the input/output numerical difference calculating section 241. The input/output numerical difference calculating section 241 then calculates the input/output numerical difference, which difference is obtained by subtracting the output pointer Pout from the input pointer Pin, and outputs the calculated input/output numerical difference to the request processing section 242. The request processing section 242 then determines whether or not this input/output numerical difference is equal to or less than a preset threshold value Reg1, and also determines whether or not this input/output numerical difference is equal to or less than 0.

At this point in time, the input/output numerical difference is [0], and this shows that received data to be read is not in the received data FIFO 220. However, in the present embodiment, the threshold value Reg1 is set to [−20], so that the input/output numerical difference is a greater value than the threshold value. This shows that, instead of outputting a FIFO Empty Error, zero data, which is dummy received data, should be output.

Therefore, the request processing section 242 outputs zero data to the received data processing section 250 (sequence S214).

Furthermore, if a read request is output from the received data processing section 250 (sequence S221) prior to the data #2 being stored in the received data FIFO 220 at the sequence S162, in the same way as at the sequence S214, the data reading section 230 outputs zero data to the received data processing section 250 (sequence S214). At this point in time, while only one data input has been made to the received data FIFO 220 (sequence S102), three read requests have been made (sequences S201, S211, and S221), so that the received data FIFO 220 is in the state shown in FIG. 4.

If a read request is output from the received data processing section 250 (sequence S231) after the data #5 has been stored in the received data FIFO 220 at the sequence S172, the read request receiving section 231 outputs this read request to the input/output numerical difference calculating section 241, and the input/output numerical difference calculating section 241 calculates the input/output numerical difference, which difference is obtained by subtracting the output pointer Pout from the input pointer Pin, and then outputs the calculated input/output numerical difference to the request processing section 242. The request processing section 242 then determines whether or not this input/output numerical difference is equal to or less than the threshold value Reg1, and also determines whether or not this input/output numerical difference is equal to or less than 0.

At this point in time, four data items are stored in the received data FIFO 220 (i.e., the data items #0, #2, #4, and #5), and three read requests have already been made (at the sequences S201, S211, and S221). Accordingly, the input/output numerical difference is [1], which is greater than 0. Therefore, the request processing section 242 reads the received data #5 from the RAM block #3, from among the RAM blocks in the received data buffer 221, that is indicated by the value [3] of the output pointer Pout (sequences S232, S233), and outputs the read received data #5 to the received data processing section 250 (sequence S234).

In this way, as a result of the request processing section 242 outputting zero data when there is no data in the received data FIFO 220 due to the non-arrival of a packet, FIFO Empty Errors are prevented from occurring too frequently.

FIG. 7 is a flowchart showing an example of an operation of the data reading section 230.

In the data reading section 230, firstly, the read request receiving section 231 waits to receive a read request from the received data processing section 250 (step S301).

When a read request is output from the received data processing section 250, the read request receiving section 231 outputs (i.e., transfers) this read request to the input/output numerical difference calculating section 241. By then subtracting the value of the output pointer Pout, which is stored in the output pointer storage section 223, from the value of the input pointer Pin, which is stored in the input pointer storage section 222, the input/output numerical difference calculating section 241 is able to determine an input/output numerical difference, which is the difference obtained by subtracting the number of times a read request was received from the number of received data items input into the FIFO. This input/output numerical difference is then output to the request processing section 242 (step S302).

When the input/output numerical difference has been output from the input/output numerical difference calculating section 241, the request processing section 242 determines whether or not the input/output numerical difference is equal to or less than the threshold value Reg1which has been stored in advance (step S303). Here, Reg1 is a negative integer, and is set to, for example, [−20].

If the input/output numerical difference is determined to be equal to or less than Reg1 (i.e., if the result of the determination in step S303 is YES), the request processing section 242 outputs FIFO Empty Error to the received data processing section 250 (step S311). Thereafter, the processing shown in FIG. 7 is ended.

In contrast, if the input/output numerical difference is determined in step S303 to be greater than Reg1(i.e., if the result of the determination in step S303 is NO), the request processing section 242 determines whether or not the input/output numerical difference is equal to or less than 0 (step S321). If the input/output numerical difference is determined to be equal to or less than 0 (i.e., if the result of the determination in step S321 is YES), the request processing section 242 outputs, for example, zero data as dummy received data (step S331), and adds 1 to the value of the output pointer Pout (step S332). Note that the term ‘zero data’ referred to here is data in which the value of all the bits is zero. For example, if the size of the received data contained in one packet is 12 bits, then the data is 0x000 (i.e., a bit string made up of 12 bits each having the value 0).

In contrast, if it is determined in step S321 that the input/output numerical difference is greater than 0 (i.e., if the result of the determination in step S321 is NO), then this shows that received data to be read is stored in the received data FIFO 220. Therefore, the request processing section 242 reads the received data from the RAM block in the received data FIFO that is indicated by the output pointer Pout, and outputs this read received data to the received data processing section 250 (step S341). Thereafter, the routine moves to step S332.

In this manner, when received data to be read is stored in the received data FIFO 220, the data reading section 230 reads and outputs this data. If, on the other hand, received data to be read has not been stored in the received data FIFO 220, then if the number of times a read request has been received is greater by a predetermined threshold value (i.e., −Reg1) or more than the number of data items input into the received data FIFO 220, the data reading section 230 outputs a FIFO Empty Error, while, if the difference obtained by subtracting the number of data items input into the received data FIFO 220 from the number of times a read request has been received is equal to or less than Reg1, the data reading section 230 outputs dummy received data.

As a result, if a retransmission request is generated so that the writing of the received data in the received data FIFO 220 is temporarily delayed, the data reading section 230 does not output a FIFO Empty Error, however, if, due to some reason or other, received data is not output to the received data FIFO 220, or the number of received data items output to the received data FIFO 220 is regularly a small number, then the data reading section 230 outputs a FIFO Empty Error.

As has been described above, as a result of the data reading section 230 reading and outputting saved data when received data to be read has been saved in the received data FIFO 220, and outputting dummy received data when received data to be read does not exist in the received data FIFO 220, it is possible to prevent FIFO Empty Errors from being generated too frequently. Moreover, because it is not necessary to delay the timings at which the received data processing section 250 outputs read requests, the received data processing section 250 is able to acquire data more quickly.

Moreover, when there is no received data to be read in the received data FIFO 220, the data reading section 230 determines the input/output numerical difference, which is a difference obtained by subtracting the number of times a read request has been received from the number of received data items input into the received data FIFO 220, and then outputs dummy received data when this input/output numerical difference is greater than a threshold value Reg1 (i.e., a negative integer), and outputs a FIFO Empty Error when this input/output numerical difference is equal to or less than the threshold value Reg1. As a result, when a retransmission request is generated and the output of received data to the received data FIFO 220 is temporarily delayed, the data reading section 230 does not output a FIFO Empty Error. On the other hand, when received data has not been output to the received data FIFO 220, or when the received data items output to the received data FIFO 220 are regularly few in number, the data reading section 230 is able to output a FIFO Empty Error. Accordingly, if the writing of data in the received data FIFO 220 is temporarily delayed due to the need to re-transmit a packet, the generation of a FIFO Empty Error is suppressed. In contrast, if, due to some reason other than the need for a packet to be retransmitted, data is not written in the received data FIFO 220, or a state in which the writing of data in the received data FIFO 220 continues to be delayed then a FIFO Empty Error can be generated.

Moreover, if dummy received data is output, the request processing section 242 adds [1] to the value of the output pointer Pout, so that the RAM block where the received data indicated by the output pointer Pout is to be read moves on to the next RAM block. As a result, as is described above, the received data processing section 250 is able to acquire data more rapidly and, moreover, it is possible to prevent dummy received data and the actual received data being duplicated and both being output to the received data processing section 250.

Here, when the data reading section 230 has output dummy data, the original data that corresponds to this dummy data is not output to the received data processing section 250. For example, in the example shown in FIG. 6, the data reading section 230 outputs zero data at the sequence S214. This zero data is dummy data that is output instead of the data #2, and the data #2 received by the wireless communication section 100 is not output to the received data processing section 250.

However, the data received by the wireless communication section 100 is data that, depending on the state of the radio waves, has a possibility of being lost, and is considered not to cause any marked deterioration in the reception performance of the wireless communication device.

Note that, if zero data is included in the received data, a determination as to whether or not the data needs to be retransmitted is made at the upper level of an application or the like, so that it is probable that retransmission requests will only be made for data that needs to be retransmitted. In this case, each time there is a delay in the writing of data in the received data FIFO due to a packet retransmission request, it is possible to shorten the overall communication time compared to when a FIFO Empty Error in which the communication must be started again from the beginning is generated.

Note that when REG1 is set to 0, in the same way as in a general wireless communication device when there is no received data to be read, the wireless communication device 1 is placed in a FIFO Empty Error state. Therefore, the wireless communication device 1 is provided with a normal mode in which Reg1=0, and a high speed mode in which Reg1 is set to a predetermined threshold value, and is able to switch between these two modes. Alternatively, it is also possible for a plurality of threshold values to be stored in advance as the value of Reg1, and for the wireless communication device 1 to switch between these values.

By employing this type of structure, a user of the wireless communication device 1 is able to adjust the frequency at which FIFO Empty Errors are generated in accordance with the communication environment of the wireless communication device 1.

Note also that it is possible for the data reading section to determine whether or not to output a FIFO Empty error based on the length of time the input/output numerical difference was equal to or less than 0.

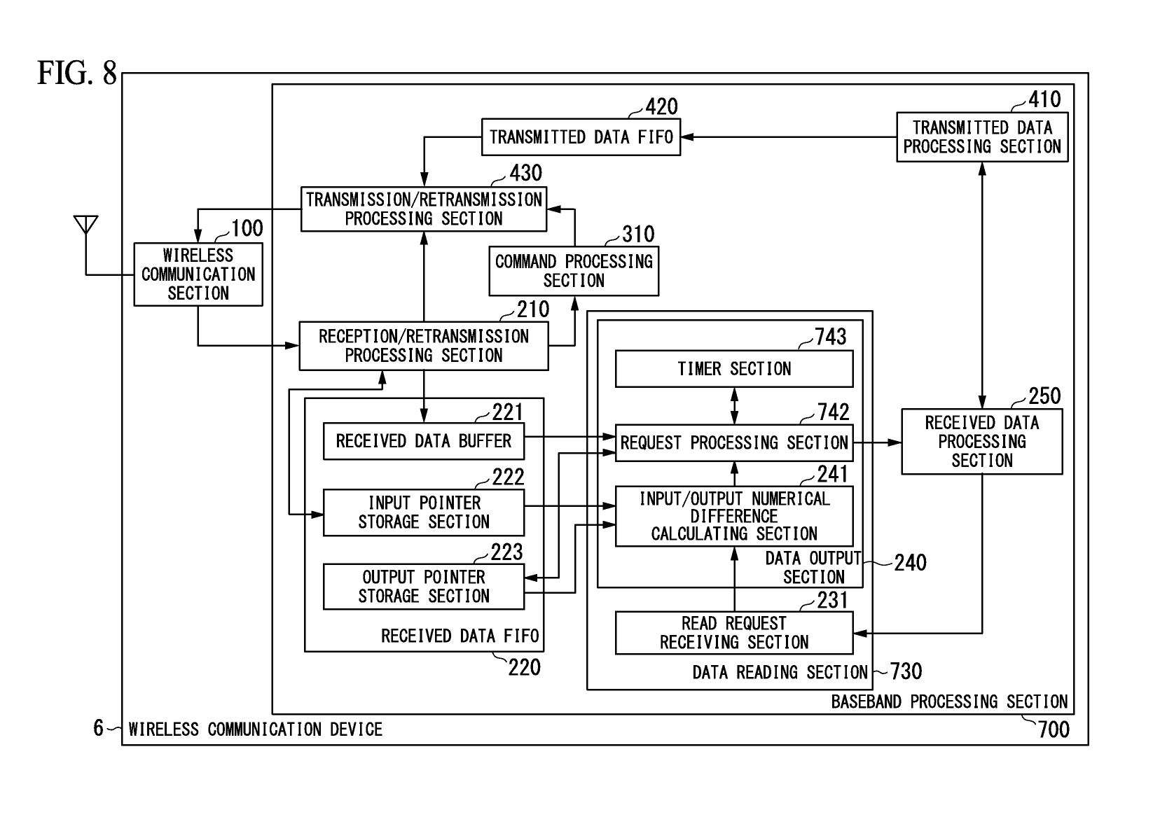

FIG. 8 is a structural view showing the schematic structure of a wireless communication device according to a first variant example of the present invention. In FIG. 8, a wireless communication device 6 is provided with a wireless communication section 100 and a baseband processing section 700. The baseband processing section 700 is provided with a reception/retransmission processing section 210, a received data FIFO 220, a data reading section 730, a received data processing section 250, a command processing section 310, a transmitted data processing section 410, a transmitted data FIFO 420, and a transmission/retransmission processing section 430. The received data FIFO 220 is provided with a received data buffer 221, an input pointer storage section 222, and an output pointer storage section 223. The data reading section 730 is provided with a read request receiving section 231, and a data output section 740. The data output section 740 is provided with an input/output numerical difference calculating section 241, a request processing section 242, and a timer section 743.

In FIG. 8, portions having the same type of function as the respective portions shown in FIG. 1 are given the same descriptive symbols (i.e., 100, 200, 220˜223, 231, 241, 250, 310, 410, 420, and 430), and any description thereof is omitted. The wireless communication device 6 differs from the wireless communication device 1 (see FIG. 1) in that it is provided with a timer section 743.

The timer section 743 measures the continuous length of time over which the input/output numerical difference was equal to or less than 0 in order to determine whether or not to output a FIFO Empty Error.

When the request processing section 742 receives a read request, in the same way as the request processing section 242 (see FIG. 1), if the input/output numerical difference is greater than 0, then it reads and outputs data from the received data FIFO 220. If, on the other hand, the input/output numerical difference is equal to or less than 0, then the request processing section 742 outputs, for example, zero data as dummy received data when the continuous length of time over which the input/output numerical difference is equal to or less than 0 was shorter than a previously determined threshold value Reg2, and outputs a FIFO Empty Error when this continuous length of time is the same as or longer than the threshold value Reg2.

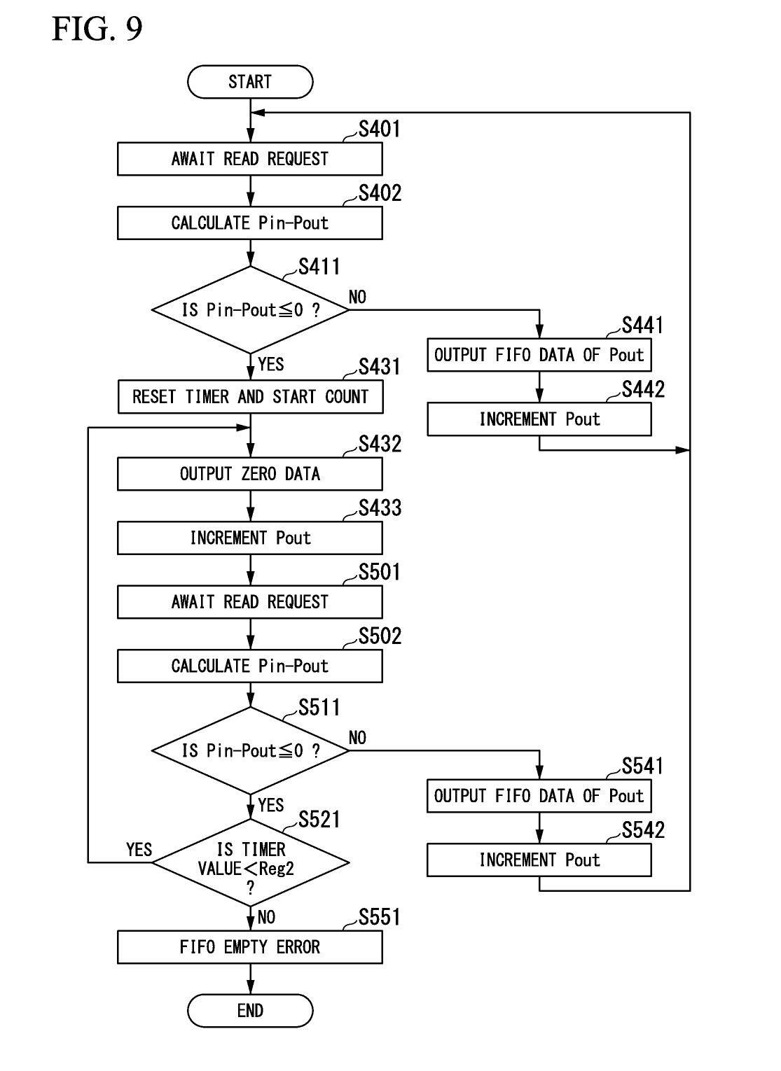

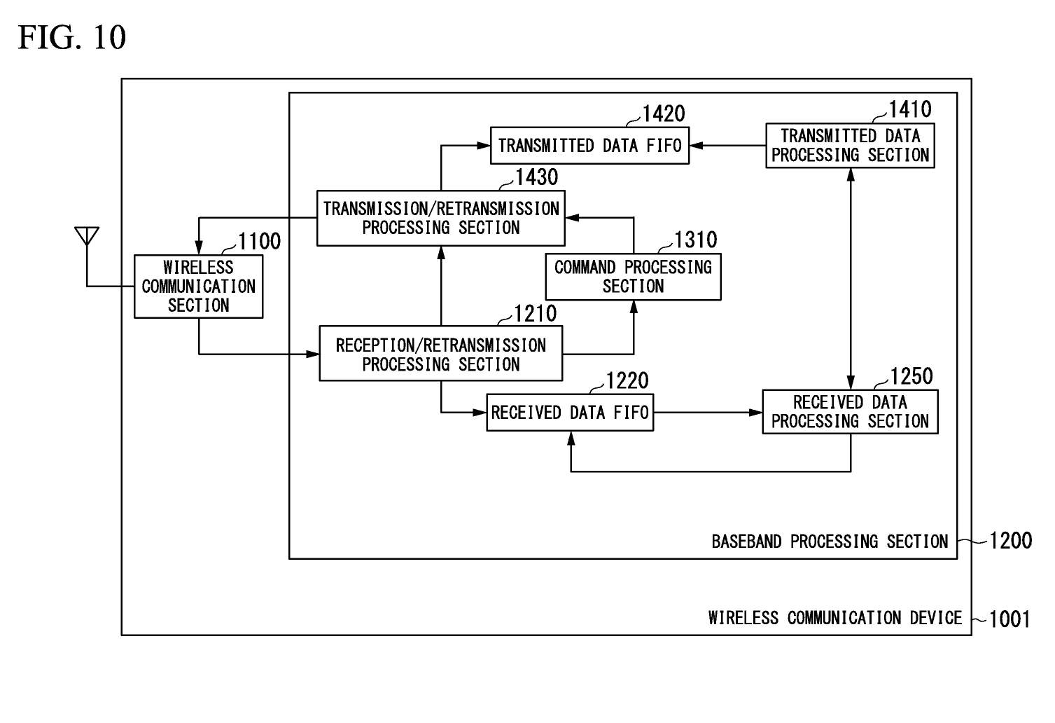

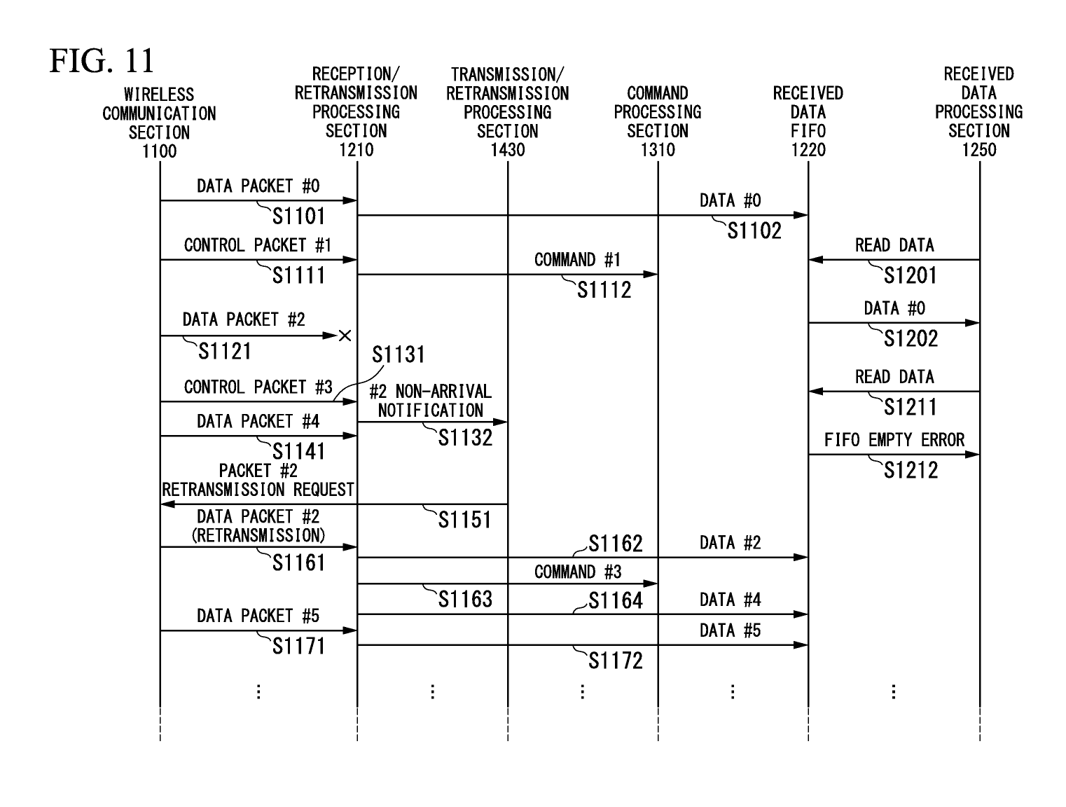

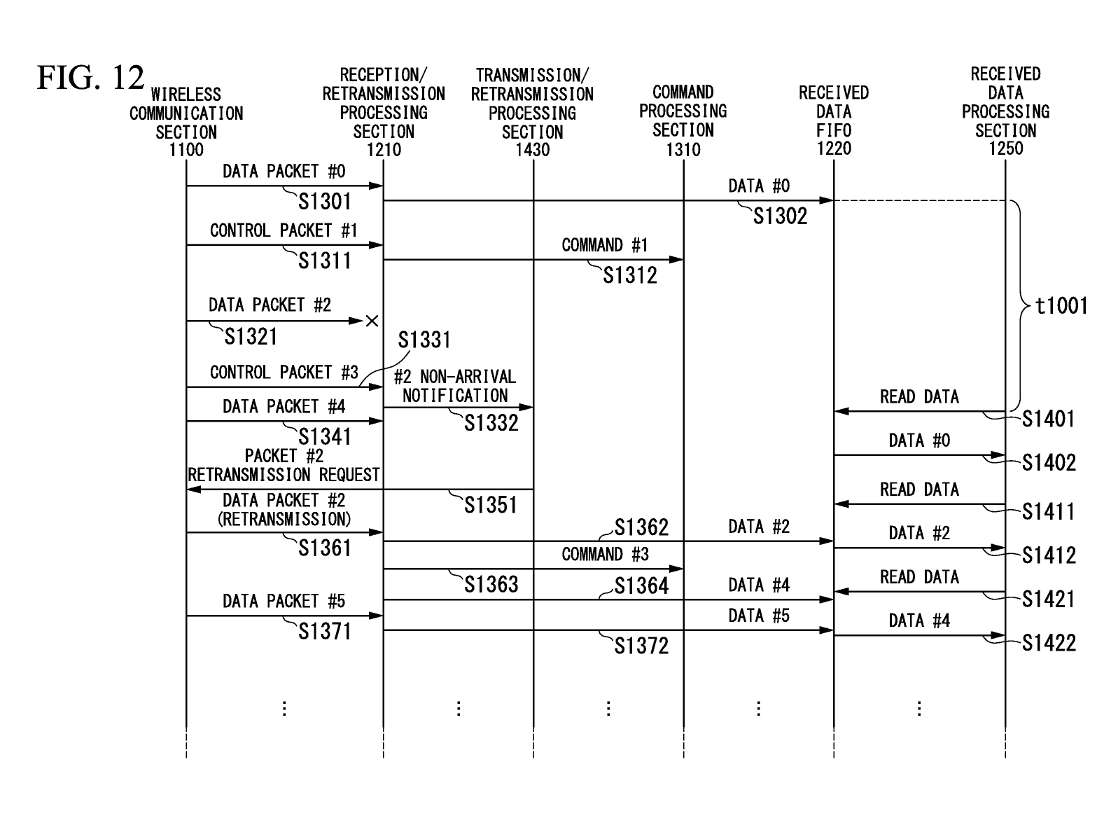

FIG. 9 is a flowchart showing an example of the operation of the data reading device 730.

Steps S401 to S402 are the same as the steps S301 to S302 in FIG. 7.

When an input/output numerical difference is output from the input/output numerical difference calculating section 241, the request processing section 742 determines whether or not the input/output numerical difference is equal to or less than 0 (step S411). If it is determined that the input/output numerical difference is greater than 0 (i.e., if the result of the determination in step S411 is NO), then this indicates that there is no received data to be read in the received data FIFO 220. Therefore, the request processing section 742 reads the received data from the RAM block indicated by the output pointer Pout in the received data FIFO 220, and outputs the read received data to the received data processing section 250 (step S441). The request processing section 742 also add 1 to the value of the output pointer Pout (step S442). Thereafter, the routine returns to step S441.

If, on the other hand, it is determined in step S411 that the input/output numerical difference is equal to or less than 0 (i.e., if the result of the determination in step S411 is YES), the request processing section 742 outputs a reset signal to the timer section 743.

Next, the timer section 743 resets the timer count value to 0 in accordance with the reset signal, and starts the timer count-up (step S431). Steps S432 to S433 are the same as the steps S331 to S332 in FIG. 7. The subsequent steps S501 to S511 are the same as steps S401 to S411.

In step S511, if it is determined that the input/output numerical difference is greater than 0 (i.e., if the result of the determination in step S511 is NO), the routine moves to step S541. Steps S541 to 5542 are the same as the steps S441 to S442. Thereafter, the routine returns to step S401.

If, on the other hand, it is determined in step S511 that the input/output numerical difference is equal to or less than 0 (i.e., if the result of the determination in step S511 is YES), the request processing section 742 acquires the timer count value from the timer section 743, and determines whether or not this is smaller than the previously determined threshold value Reg2(step S521).

If it is determined that the timer count value is smaller than the threshold value Reg2 (i.e., if the result of the determination in step S521 is YES), then this indicates that the continuous length of time over which the input/output numerical difference remained equal to or less than 0, namely, the continuous length of time over which no received data to be read was present in the received data FIFO was comparatively short. In this case, the routine shifts to step S432, and zero data is output to the received data processing section 250.

If, on the other hand, it is determined in step S521 that the timer count value is equal to or greater than the threshold value Reg2(i.e., if the result of the determination in step S521 is NO), then this indicates that the continuous length of time over which the input/output numerical difference remained equal to or less than 0, namely, the continuous length of time over which no received data to be read was present in the received data FIFO was comparatively long. In this case, the request processing section 742 outputs a FIFO Empty Error to the received data processing section 250 (step S551). Thereafter, the processing shown in FIG. 9 is ended.

As is described above, when received data to be read is stored in the received data FIFO 220, the data reading section 730 reads and outputs that stored data. On the other hand, when there is no received data to be read in the received data FIFO 220, then if the continuous length of time for which the received data FIFO remains without received data to be read is equal to or longer than the predetermined threshold value Reg2, the data reading section 730 outputs a FIFO Empty Error, while if the continuous length of time for which the received data FIFO remains without received data to be read is less than the predetermined threshold value Reg2, the data reading section 730 outputs dummy received data.

As a result of this, in the same way as the data reading section 230 (see FIG. 1), the data reading section 730 does not output a FIFO Empty Error when a retransmission request is generated and the output of received data to the received data FIFO 220 is temporarily delayed, however, the data reading section 730 does output a FIFO Empty

Error when received data is not output to the received data FIFO 220 or when a consistently small quantity of received data is output to the received data FIFO 220.

Accordingly, it is possible to suppress FIFO Empty Errors being generated when the writing of data in the received data FIFO 220 is temporarily delayed due to a packet being retransmitted, while if a state in which the writing of data in the received data FIFO 220 continues to be delayed due to some reason other than the retransmission of a packet, then a FIFO Empty Error can be generated.

Note that it is also possible for a program that achieves the functions of each section of the wireless communication device 1 or of each section of the wireless communication device 6 to be recorded on a computer-readable recording medium, and for the processing of each section to be performed by causing a computer system to read and execute the program recorded on this recording medium. Note that the term ‘computer system’ used here includes both OS and hardware such as peripheral devices and the like.

Moreover, if a WWW system is being employed, then the term ‘computer system’ may also include a homepage providing environment (or display environment).

Moreover, the term ‘computer readable recording medium’ also refers to portable media such as flexible disks, magneto-optical disks, ROM, and CD-ROM and the like, and storage devices such as hard disks that are built into a computer system. Furthermore, ‘computer readable recording medium’ includes devices that dynamically hold programs for a short time such as communication lines when the program is being transmitted via a network such as the Internet or via a communication circuit such as a telephone line, and also includes devices that hold a program for a fixed time such as the internal volatile memory in a computer system which forms the server or client when, as is described above, the program is transmitted via a network such as the Internet or via a communication circuit such as a telephone line. Moreover, the program may be one that performs a portion of the above-described functions, or may be one that performs the above functions in combination with a program that is already recorded on a computer system.

An embodiment of the present invention has been described above in detail with reference made to the drawings, however, the specific structure thereof is not limited to this embodiment, and various design modifications and the like are included therein insofar as they do not depart from the spirit or scope of the present invention.

Priority is claimed on Japanese Patent Application No. 2010-227281, filed Oct. 7, 2010, the contents of which are incorporated herein by reference.

### INDUSTRIAL APPLICABILITY

The present invention can be applied to data reading devices of communication devices that temporarily store received data in a FIFO, and read the temporarily stored received data from the FIFO. According to the present invention, a communication device is able to prevent FIFO Empty Errors from occurring too frequently, and a received data processing section of this communication device is able to acquire data more rapidly.

### DESCRIPTION OF THE REFERENCE NUMERALS

1 Wireless communication device
100 Wireless communication section
200 Baseband processing section
210 Reception/retransmission processing section
220 Received data FIFO
221 Received data buffer
222 Input pointer storage section
223 Output pointer storage section
230 Data reading section
231 Read request receiving section
240 Data output section
241 Input/output numerical difference calculating section
242 Request processing section
250 Received data processing section
310 Command processing section
410 Transmitted data processing section
420 Transmitted data FIFO
430 Transmission/retransmission processing section

1. A data reading device in a communication device in which received data is temporarily stored in first in, first out memory (FIFO), the data reading device reading the received data from the FIFO and comprising:
a read request receiving section that receives a read request for the received data; and
a data output section that, when the read request receiving section receives the read request, then if the received data to be read is stored in the FIFO, reads and outputs the stored received data to be read,
while if the received data to be read is not stored in the FIFO and predetermined conditions have been established, the data output section outputting dummy received data,
while if the received data to be read is not stored in the FIFO and predetermined conditions have also not been established, the data output section outputting an error.

2. The data reading device according to claim 1, wherein the data output section includes:
an input/output numerical difference calculating section that determines an input/output numerical difference, which difference is obtained by subtracting the number of times the read request was received from the number of received data items input into the FIFO; and
a request processing section that, when the read request receiving section receives the read request, then if the input/output numerical difference is a positive number, reads and outputs the stored received data to be read from the FIFO,
while if the input/output numerical difference is zero or is a value between zero and a predetermined threshold value, the request processing section outputting dummy received data,
while if the input/output numerical difference is equal to or less than the threshold value, the request processing section outputting an error.

3. The data reading device according to claim 1, wherein the data output section includes:
an input/output numerical difference calculating section that determines an input/output numerical difference, which difference is obtained by subtracting the number of times the read request was received from the number of received data items input into the FIFO;
a timer section that, when the input/output numerical difference is equal to or less than zero, measures the continuous length of time that the input/output numerical difference was equal to or less than zero; and
a request processing section that, when the read request receiving section receives the read request, then if the input/output numerical difference is a positive number, reads and outputs the stored received data to be read from the FIFO,
while if the input/output numerical difference is equal to or less than zero and the continuous length of time is a shorter time than a predetermined threshold value, the request processing section outputting dummy received data,
while if the input/output numerical difference is equal to or less than zero and the continuous length of time is the same time as the threshold value or is a longer time than the threshold value, the request processing section outputting an error.

4. The data reading device according to claim 2, wherein, when the dummy received data is output, the data output section moves the particular RAM block that contains the received data to be read, from among the RAM blocks making up the FIFO, forward to the next RAM block.

5. A communication device comprising:
a receiving section that receives data;
first in, first out memory (FIFO) that temporarily stores received data received by the receiving section;
a data reading section that reads the received data from the FIFO; and
a received data processing section that makes a request to the data reading section for received data, and processes received data output from the data reading section, wherein,
when a request for received data is made from the data processing section, then if the received data to be read is stored in the FIFO, the data reading section reads and outputs the stored received data to be read, while if the received data to be read is not stored in the FIFO and predetermined conditions have been established, the data reading section outputs dummy received data, while if received data to be read is not stored in the FIFO and the predetermined conditions have also not been established, the data reading section outputs an error.

6. A data reading method for use in a communication device in which received data is temporarily stored in first in, first out memory (FIFO), the data reading method comprising:
a receiving step in which a receiving section receives data and stores it in the FIFO;
a read request step in which the received data processing section requests the data reading section to read received data from the FIFO; and
a data output step in which, when the data reading section receives the received data read request in the read request step, then if the received data to be read is stored in the FIFO, the data reading section reads and outputs the stored received data to be read, while if the received data to be read is not stored in the FIFO and predetermined conditions have been established, the data reading section outputs dummy received data, while if received data to be read is not stored in the FIFO and the predetermined conditions have also not been established, the data reading section outputs an error.

7. A non-transitory computer readable medium containing a program for causing to be executed on a computer that is serving as a data reading device in a communication device in which received data is temporarily stored in first in, first out memory (FIFO),
a data output step in which, when the data request is received, then if the received data to be read is stored in the FIFO, the stored received data to be read is read and output, while if the received data to be read is not stored in the FIFO and predetermined conditions have been established, dummy received data is output, while if received data to be read is not stored in the FIFO and the predetermined conditions have also not been established, an error is output.

8. The data reading device according to claim 3, wherein, when the dummy received data is output, the data output section moves the particular RAM block that contains the received data to be read, from among the RAM blocks making up the FIFO, forward to the next RAM block.
